(19) United States
(12) Patent Application Publication
(10) Pub. No.: US 2006/0129646 A1
(43) Pub. Date: Jun. 15, 2006

(54) Method and system for providing SIP based instance messaging service to mobile terminal without SIP function through IP multimedia subsystem network, and instance messaging proxy server therefor

(76) Inventors: Eun Jun Rhee, Daejeon (KR); Soon Choul Kim, Daejeon (KR); Won Ryu, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/106,919

(22) Filed: Apr. 15, 2005

(30) Foreign Application Priority Data
Dec. 13, 2004 (KR) 10-2004-0104937

(51) Int. Cl. G06F 15/16

(52) U.S. Cl. 709/206; 709/227

(57) ABSTRACT

The present invention provides a method and system for providing a SIP based Instance Messaging (IM), and an IM proxy server therefor. An IM proxy server for performing a proxy function in a mobile communication network is configured to provide an IM service between a mobile terminal lacking an SIP function and an IM server. Further, the IM proxy server converts an IM message received from the mobile terminal into a corresponding SIP message mapped thereto, transmits the SIP message to the IM server through a call session control server, converts an SIP message received from the IM server through the call session control server into an IM message recognizable by the mobile terminal, and transmits the IM message to the mobile terminal, thus providing the SIP based IM service to the mobile terminal lacking an SIP function.

### BACKGROUND OF THE INVENTION

1. Field of the Invention

The present invention relates, in general, to session initiation protocol based instance messaging service and, more particularly, to a method and system for providing session initiation protocol based instance messaging service to a mobile terminal incapable of supporting a session initiation protocol function through an Internet protocol multimedia subsystem network, and an instance messaging proxy server therefor.

2. Description of the Prior Art

Recently, the Third Generation Project Partnership (3GPP) has proposed a structure of an Internet-protocol Multimedia Subsystem (IMS) network as a method of providing all-Internet Protocol (IP)-based multimedia service in a mobile communication network. Further, standardization allowing all multimedia service control procedures provided through the IMS network to use Session Initiation Protocol (SIP) have progressed.

FIG. 1 is a view showing the configuration of a conventional network for providing SIP based IM service to a mobile terminal having an SIP function. Referring to FIG. 1, a plurality of first and second mobile terminals 10 and 10′, having an SIP function, that is connected to a base station 21 of a mobile communication network 20 in a wireless manner is provided with an SIP stack. The mobile terminal provided with an SIP stack includes an application program for operating in conjunction with an IM server that provides IM service. The mobile communication network 20 may be a synchronous packet mobile communication network (Code Division Multiple Access [CDMA] 2000) or an asynchronous packet mobile communication network (Wideband CDMA: WCDMA).

The mobile communication terminal 10 having an SIP function connected to the mobile communication network 20 through the base station 21 is connected to a call session control server 31 in an IMS network 30 through internal components 22 and a Gateway General packet radio service (GPRS) Support Node (GGSN)/Packet Data Serving Node (PDSN) 23 in the mobile communication network 20. The call session control server 31, which is a component of the IMS network 30, is connected to an SIP based IM server 40. The IM server 40 is a service server providing an Instance Messaging (IM) service, for example, MSN, IRC, ICQ, etc.

FIG. 2 is a flowchart of a conventional method of providing an SIP based IM service to a mobile terminal having an SIP function through an IMS network. With reference to FIG. 2, the method of providing an SIP based IM service to a mobile terminal having an SIP function through the IMS network is described. If the first mobile terminal 10 having an SIP function requests the call session control server 31, which is a component of the IMS network 30, using a REGISTER message at step S100, the call session control server 31 registers the subscriber information of the first mobile terminal 10 and transmits registration results to the first mobile terminal 10 using an SIP status message including 200 OK status information at step S101. In this way, the first mobile terminal 10 having an SIP function is registered in the IMS network 30. The first mobile terminal 10 requests the SIP-based IM server 40 to change its status or the status of the other party and to add or delete the first mobile terminal 10 to or from a list of the other party through the call session control server 31, using a SUBSCRIBE message at steps S102 and S103. The IM server 40 transmits an SIP status message including 200 OK status information, indicating that the SUBSCRIBE message has been normally received, to the first mobile terminal 10 via the call session control server 31 at steps S104 and S105. Further, the IM server 40 reads subscriber profile in response to the SUBSCRIBE request, performs a login procedure for a user, and transmits login results to the first mobile terminal 10 through the call session control server 31 using a NOTIFY message at steps S106 and S107. The first mobile terminal 10 transmits an SIP status message including 200 OK status information, used to confirm that the NOTIFY message has been received, to the IM server 40 through the call session control server 31 at steps S108 and S109.

Thereafter, if the first mobile terminal 10 transmits contents to be transmitted to the other party, the second mobile terminal 10′ having an SIP function, to the IM server 40 through the call session control server 31 using a MESSAGE at steps S110 and S111, the IM server 40 transmits an SIP status message including 200 OK status information, used to confirm that the contents have been normally received, to the first mobile terminal 10 through the call session control server 31 at steps S112 and S113. Then, the IM server 40 transmits the contents to the other party, the second mobile terminal 10′, through the call session control server 31 using a MESSAGE so as to transmit the contents to the second mobile terminal 10′ at steps S114 and S115. The second mobile terminal 10′ transmits an SIP status message including 200 OK status information, indicating that the contents have been normally received, to the SIP based IM server 40 through the call session control server 31 at steps S116 and S117.

According to the above procedure, the first mobile terminal 10, that is, a transmitting party, can transmit messages to the second mobile terminal 10′, that is, the other party (receiving party). In this case, the second mobile terminal 10′ can also transmit messages to the first mobile terminal 10 using the procedure. As described above, all SIP messages, transmitted through the IMS network 30 in the mobile communication network, are transmitted through the call session control server 31, which is the component of the IMS network.

However, in order to use SIP based IM service through the IMS network 20, the first and second terminals 10 and 10′ must support an SIP stack capable of processing SIP messages. Further, there is a disadvantage in that, since a typical mobile terminal that have been previously used does not support the SIP stack, a user must purchase a new mobile terminal provided with an SIP stack to use the SIP based IM service provided through the IMS network 30.

Moreover, there is a disadvantage in that it is difficult for a service provider, desiring to provide SIP based IM service through the IMS network 30, to activate the SIP based IM service in an environment in which a mobile terminal having an SIP function does not exist, and the service provider must wait for a service user to purchase a new terminal having an SIP function. From the standpoint of a mobile communication network service provider, it is difficult to expect to receive income from traffic using the SIP based IM service through the IMS network.

In the meantime, for technology of providing an instance messaging service through a mobile communication network, Korean Patent Laid-Open Publication No. 2004-73888, entitled “Instant messaging service method and system through a mobile communication network”, discloses, in particular, a method and system for allowing a mobile terminal connected to the Internet through a CDMA mobile communication network to exchange an Instant Message (IM) with another desired party. Further, Korean Patent Laid-Open Publication No. 2003-86763, entitled “SIP based instant messaging service method in a mobile communication packet network”, discloses an SIP based instant messaging service method of providing an instant messaging (IM) service regardless of the current location of a mobile subscriber and an interface network in a mobile communication packet network. However, these patents do not disclose a method of providing an IM service to a mobile terminal lacking an SIP function.

Moreover, a related thesis (entitled “Service control architecture in the UMTS IP multimedia core network subsystem” by Grech, M. L. F, in 3G Mobile Communication Technologies, 2002. Third International Conference, Conf. Publ. No. 489, pp. 22-26, 8-10 May 2002.) discloses an IMS control structure in a Universal Mobile Telecommunications System (UMTS) network of 3GPP.

Therefore, since, in a recently proposed IMS network structure, control operations for all multimedia services are based on SIP, a great need for technology capable of providing an IM service even to a mobile terminal lacking an SIP function through the IMS network has arisen.

### SUMMARY OF THE INVENTION

The present invention provides a method and system for providing an SIP based IM service, in which IM application software is installed in a mobile terminal lacking an SIP function to use IM service through communication with an IM proxy server, and the IM proxy server converts messages between the mobile terminal lacking an SIP function and an SIP based IM server into recognizable messages and transmits the converted messages, thus providing the SIP based IM service to the mobile terminal lacking an SIP function through an IMS network, and to provide the Instance Messaging (IM) proxy server for the SIP based IM service provision method and system.

The present invention provides a method of providing a Session Initiation Protocol (SIP) based Instance Messaging (IM) service to a mobile terminal lacking an SIP function through an Internet-protocol Multimedia Subsystem (IMS) network, comprising the IM proxy server configuration step of configuring an IM proxy server which is connected to a call session control server of the IMS network communicating with an SIP based IM server and performs a proxy function in a mobile communication network so that the IM service is provided between the mobile terminal lacking an SIP function, connected to the IMS network through the mobile communication network, and the IM server through the IMS network; the downloading step of the mobile terminal lacking an SIP function downloading IM application software from a corresponding server to use the SIP based IM service through communication with the IM proxy server; and the message relaying step of the IM proxy server converting an IM message, received from the mobile terminal lacking an SIP function, into an SIP message mapped thereto, transmitting the SIP message to the IM server through the call session control server, converting an SIP message, received from the IM server through the call session control server, into an IM message recognizable by the mobile terminal lacking an SIP function, and transmitting the IM message to the mobile terminal lacking an SIP function.

Further, the present invention provides a system for providing a Session Initiation Protocol (SIP) based Instance Messaging (IM) service to a mobile terminal lacking an SIP function through an Internet-protocol Multimedia Subsystem (IMS) network, comprising a mobile terminal lacking an SIP function, in which IM application software is installed to use the SIP based IM service; an IM server for providing the SIP based IM service to the mobile terminal lacking an SIP function; a call session control server of the IMS network for relaying SIP messages between the mobile terminal lacking an SIP function and the IM server; and an IM proxy server connected to the call session control server through the IMS network, the IM proxy server performing a proxy function in a mobile communication network so that the IM service is provided between the mobile terminal lacking an SIP function, connected to the IMS network through the mobile communication network, and the IM server through the IMS network, wherein the IM proxy server converts an IM message received from the mobile terminal lacking an SIP function into a corresponding SIP message mapped thereto, transmits the SIP message to the IM server through the call session control server, converts an SIP message received from the IM server through the call session control server into an IM message recognizable by the mobile terminal, and transmits the IM message to the mobile terminal.

In addition, the present invention provides an Instance Messaging (IM) proxy server for providing a Session Initiation Protocol (SIP) based Instance Messaging (IM) service to a mobile terminal lacking an SIP function through an Internet-protocol Multimedia Subsystem (IMS) network, the IM proxy server being connected to a call session control server of the IMS network that communicates with an SIP based IM server, the IM proxy server performing a proxy function in a mobile communication network so as to provide an IM service between a mobile terminal lacking an SIP function, connected to the IMS network through the mobile communication network, and the IM server, comprising an interface unit for interfacing with both the mobile terminal lacking an SIP function and the call session control server; a non-SIP message generation and analysis unit for analyzing an IM message received from the mobile terminal lacking an SIP function through the interface unit, extracting data required to convert the IM message into an SIP message recognizable by the call session control server from the IM message, and then transmitting the SIP message to the interface unit; an SIP message generation and analysis unit for analyzing an SIP message received from the call session control server through the interface unit, extracting data required to convert the SIP message into an IM message recognizable by the mobile terminal lacking an SIP function from the SIP message, and then transmitting the IM message to the interface unit; and a message conversion unit for converting the IM message received from the non-SIP message analysis and generation unit into an SIP message mapped thereto, transmitting the SIP message to the non-SIP message analysis and generation unit, converting the SIP message received from the SIP message analysis and generation unit into an IM message mapped thereto, and transmitting the IM message to the SIP message analysis and generation unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the configuration of a conventional network for providing an SIP based IM service to a mobile terminal having an SIP function;

FIG. 2 is a flowchart of a conventional method of providing an SIP based IM service to a mobile terminal having an SIP function through an IMS network;

FIG. 3 is a view showing the configuration of a network for providing an IM service to a mobile terminal lacking an SIP function according to an embodiment of the present invention;

FIG. 4 is a functional block diagram of an IM proxy server for performing a method of providing an SIP based IM service to a mobile terminal lacking an SIP function according to an embodiment of the present invention; and

FIGS. 5a and 5b are flowcharts of a method of providing an SIP based IM service to a mobile terminal lacking an SIP function through an IMS network according to the present invention.

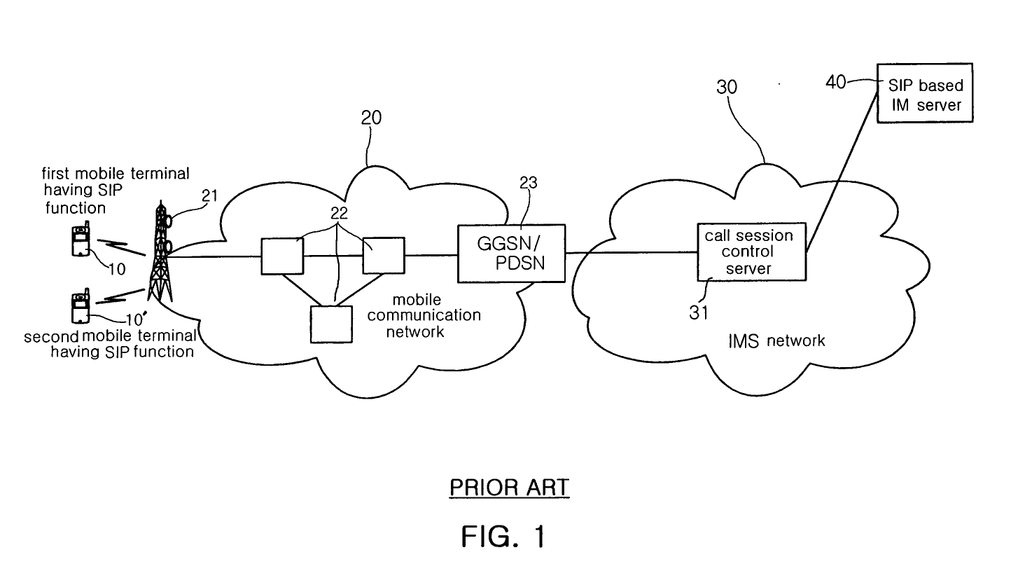

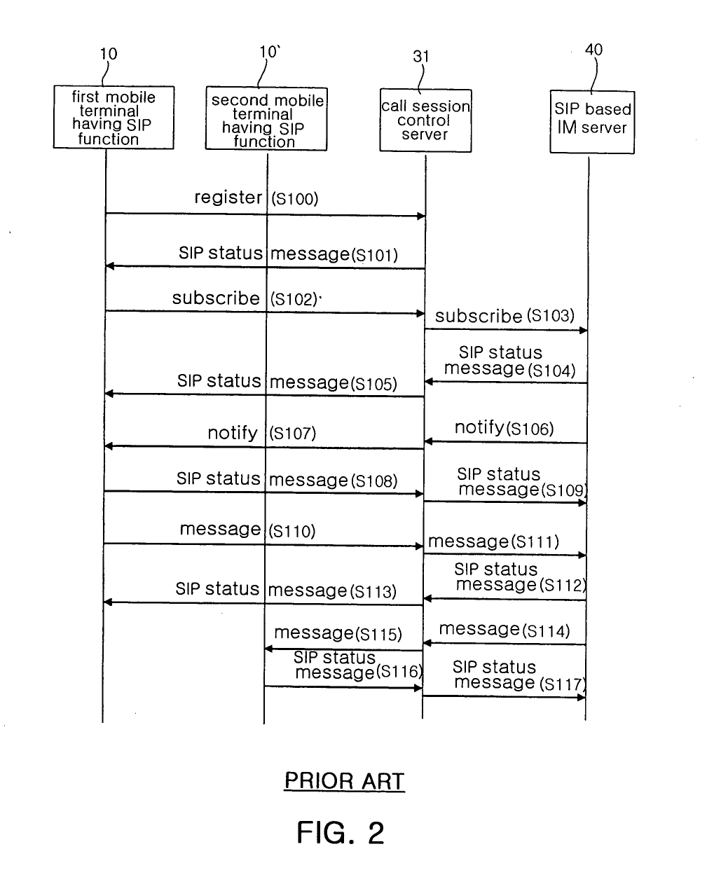

### DESCRIPTION OF THE PREFERRED EMBODIMENTS

Preferred embodiments of the present invention are described with reference to the attached drawings. Reference now should be made to the drawings, in which the same reference numerals are used throughout the different drawings to designate the same or similar components. In the following description of the present invention, detailed descriptions may be omitted if it is determined that the detailed descriptions of related well-known functions and construction may make the gist of the present invention unclear.

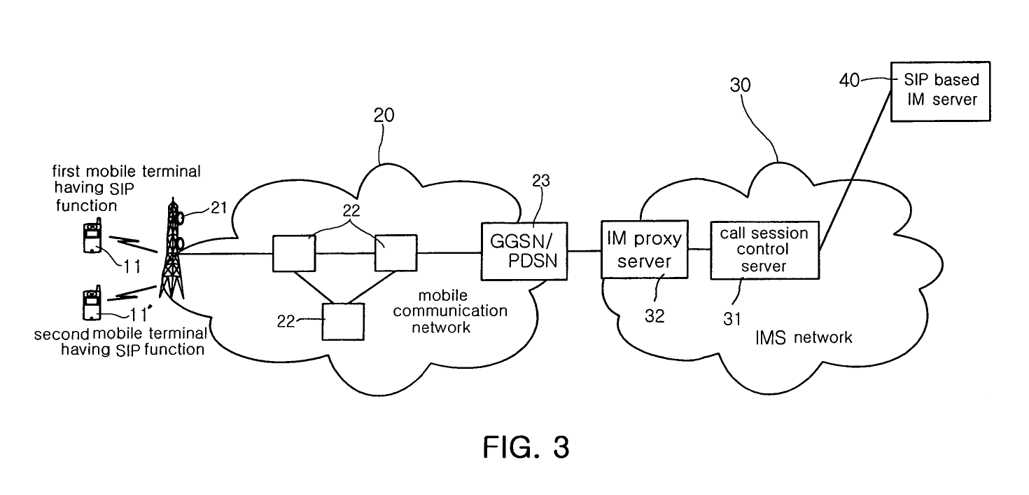

FIG. 3 is a view showing the configuration of a network for providing an Instance Messaging (IM) service to a mobile terminal lacking an SIP function according to an embodiment of the present invention. Referring to FIG. 3, a plurality of mobile terminals 10 and 11 is connected to a base station 21 of a mobile communication network 20 in a wireless manner. In this case, the mobile terminals include the mobile terminal 10 that is provided with an SIP stack and supports an SIP function, and the mobile terminal 11 that is not provided with an SIP stack and does not support an SIP function. However, it should be noted that the present invention is implemented on the basis of the mobile terminal 11 that is not provided with an SIP stack. The mobile terminal 10 provided with an SIP stack includes an application program for operating in conjunction with an IM server 40 that provides an IM service. However, the mobile terminal 11 lacking an SIP stack preferably downloads IM application software for an IM service from a corresponding server and causes the IM application software to be installed therein, so as to operate in conjunction with the IM server 40 that provides an IM service. In particular, the present invention proposes technology for providing an IM service to the mobile terminal 11 not supporting an SIP function.

As shown in FIG. 3, the mobile terminals 10 and 11 can be connected to the mobile communication network 20 through the base station 21. As described above, the mobile communication network 20 may be a synchronous packet mobile communication network (CDMA 2000) or an asynchronous packet mobile communication network (WCDMA). Depending on the synchronous packet mobile communication network (CDMA 2000) or the asynchronous packet mobile communication network (WCDMA), the internal components 22 of the mobile communication network 20 can be differently constructed. For example, the synchronous packet mobile communication network (CDMA 2000) may include a Base Station Controller (BSC), a Mobile Switching Center (MSC), a Gateway GPRS Support Node, a Home Location Register (HLR), etc., as the internal components 22. Further, the asynchronous packet mobile communication network (WCDMA) may include a Radio Network Controller (RNC), an MSC, an HLR, a Packet Data Serving Node (PDSN), etc., as the internal components 22.

Because the GGSN or PDSN 23 of the mobile communication network 20 is connected to an IM proxy server 32 of the IMS network 30, the mobile terminal 11 lacking an SIP function according to the present invention is connected to the IMS network 30. The IMS network 30 includes a call session control server 31 and the IM proxy server 32. The call session control server 31, which is a component of the IMS network 30, is connected to the SIP based IM server 40.

In order to provide an SIP based IM service to the mobile terminal 11 lacking an SIP function, the IM proxy server 32 converts an IM message received from the mobile terminal 11 lacking an SIP function into a corresponding SIP message mapped thereto, transmits the SIP message to the IM server 40 through the call session control server 31, converts an SIP message received from the IM server 40 through the call session control server 31 into an IM message recognizable by the mobile terminal 11 lacking an SIP function, and transmits the IM message to the mobile terminal 11.

The IM server 40 is a server for providing an IM service, for example, MSN, IRC, ICQ, etc. In particular, the present invention provides an SIP based IM service to the user of the mobile terminal 11 lacking an SIP function connected to the IM server 40 through the IM proxy server 32.

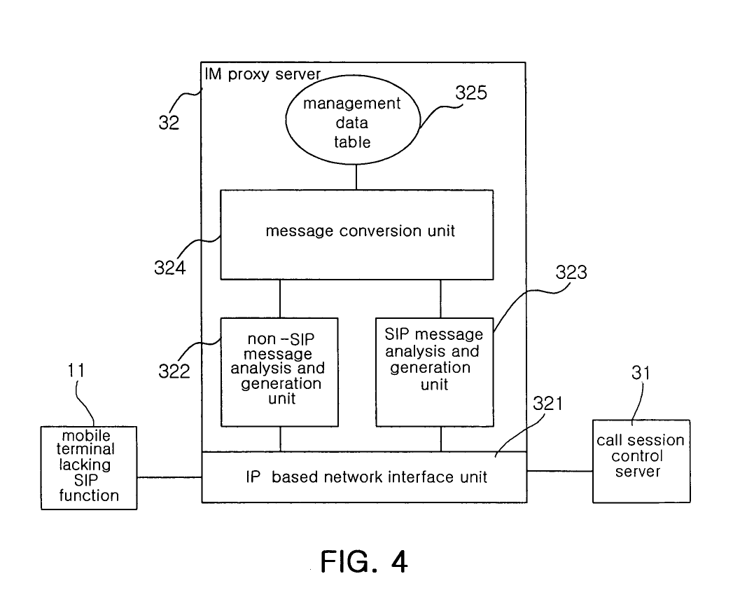

FIG. 4 is a functional block diagram of an IM proxy server for performing a method of providing an SIP based IM service to a mobile terminal lacking an SIP function according to the present invention. Before the description of FIG. 4, the user of the mobile terminal 11 lacking an SIP function downloads IM application software required to use an IM service by communicating with the IM proxy server 32 and installs the IM application software in the mobile terminal 11, in order to use an SIP based IM service through the IMS network 30. This procedure need only be performed once at the time of initiating the IM service. The IM application software is downloaded by allowing the mobile terminal to access a corresponding server for providing the application software through the Internet connection and download the IM application software from the server, as per a typical method. This IM application software is used for a mobile terminal lacking an SIP function, and allows the mobile terminal to use the IM service through communication with the IM proxy server 32. Thereafter, the user of the mobile terminal uses the IM service through the installed IM application software.

Hereinafter, with reference to FIG. 4, the IM proxy server 32 according to the present invention is described in detail. As shown in FIG. 4, the IM proxy server 32 for performing the method of providing an SIP based IM service includes an IP based network interface unit 321, a non-SIP message analysis and generation unit 322, an SIP message analysis and generation unit 323, a message conversion unit 324, and a management data table 325.

The IP based network interface unit 321 is used to communicate with both the mobile terminal 11, incapable of supporting an SIP function, and the call session control server 31, which is a component of the IMS network. The IP based network interface unit 321 dispenses messages, received from both the mobile terminal 10 and the call session control server 31, to the non-SIP message analysis and generation unit 322 and the SIP message analysis and generation unit 323. In this case, the non-SIP message analysis and generation unit 322 analyzes a message received from the mobile terminal 11 lacking an SIP function, extracts data, required to convert the message into a message recognizable by the call session control server 31, from the analyzed message, and transmits the extracted data to the message conversion unit 324 so as to perform message conversion. Further, the SIP message analysis and generation unit 323 analyzes an SIP message received from the SIP based IM server 40 through the call session control server 31, extracts data, required to convert the SIP message into a message recognizable by the mobile terminal 11 lacking an SIP function, from the analyzed SIP message, and transmits the extracted data to the message conversion unit 324 so as to perform message conversion.

The message conversion unit 324 performs the conversion of data format to configure messages mapped to input messages, using the data extracted by the non-SIP message analysis and generation unit 322 and the SIP message analysis and generation unit 323, respectively. That is, the message conversion unit 324 converts a message received from the mobile terminal 11 lacking an SIP function through the non-SIP message analysis and generation unit 322, into a corresponding SIP message recognizable by the call session control server 31. Further, the message conversion unit 324 converts an SIP message, received from the call session control server 31 through the SIP message analysis and generation unit 323, into a message recognizable by the mobile terminal 11 lacking an SIP function.

The messages converted in this way are transmitted again to the non-SIP message analysis and generation unit 322 and the SIP message analysis and generation unit 323. The transmitted messages are dispensed to destinations (the mobile terminal or call session control server) through the IP based network interface unit 321. In this case, the management data table 325 stores data required for data mapping according to the message conversion performed by the message conversion unit 324.

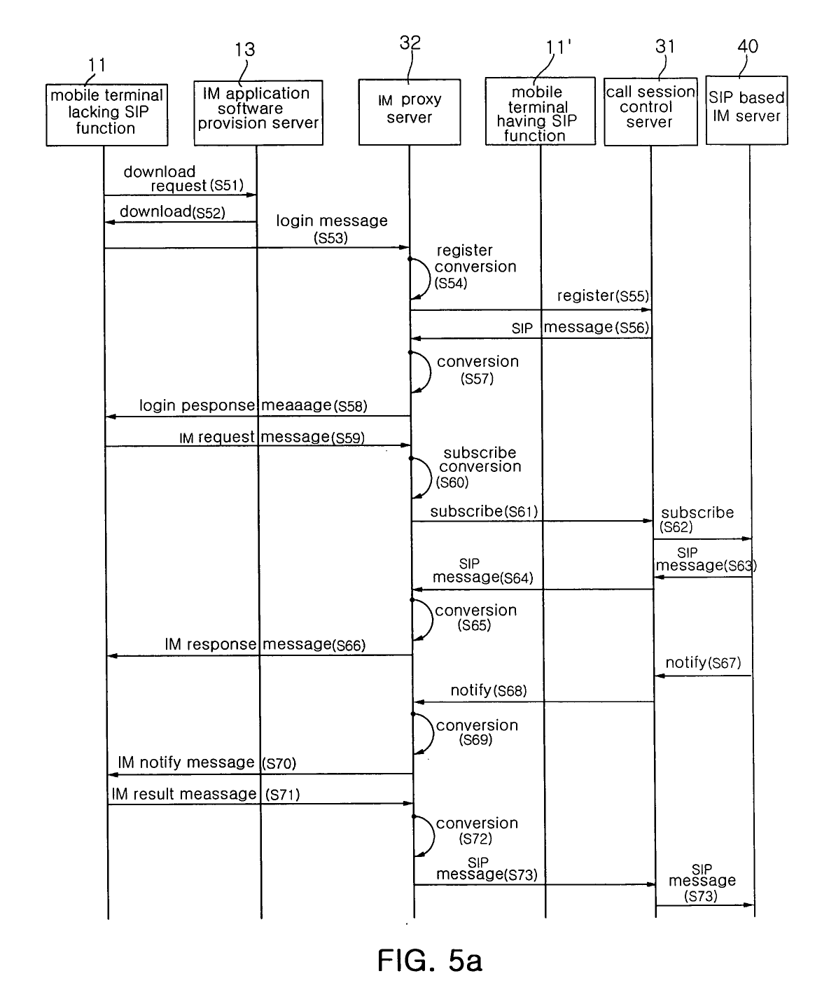

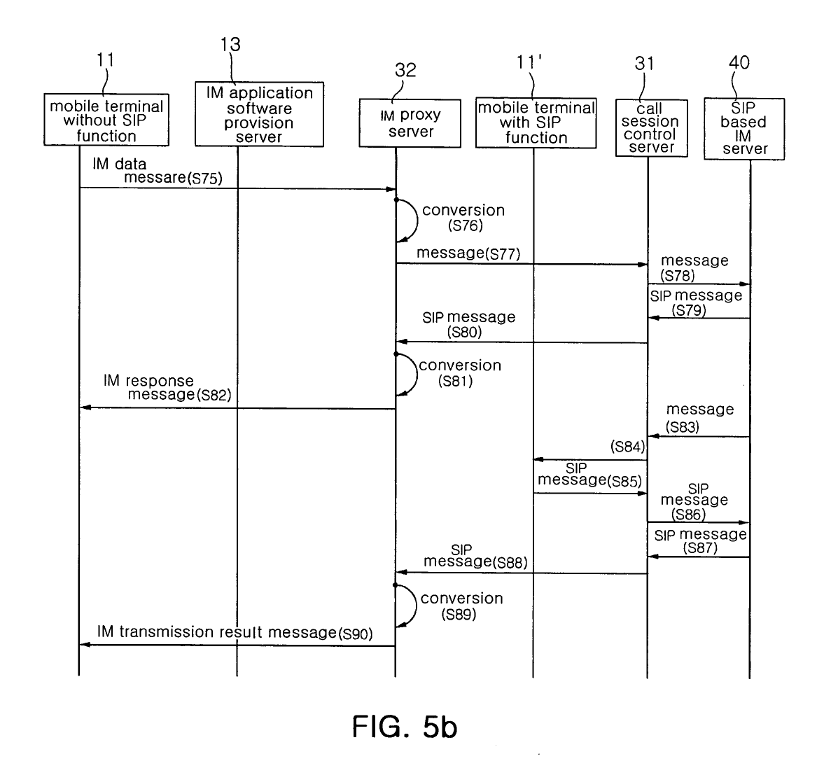

FIGS. 5a and 5b are flowcharts of a method of providing an SIP based IM service to a mobile terminal lacking an SIP function through an IMS network according to the present invention. Referring to FIGS. 5a and 5b, the user of a first mobile terminal 11 lacking an SIP function must download IM application software required to use an IM service through communication with the IM proxy server 32 and install the IM application software in the mobile terminal, so as to use the SIP based IM service through the IMS network, as described above, at steps S51 and S52. This procedure need only be performed once at the time of initiating the IM service. That is, the user of the first mobile terminal 11 lacking an SIP function requests an IM application software provision server 13 to transmit the IM application software at step S51, downloads the IM application software from the IM application software provision server 13, and installs the IM application software at step S52. As described above, the IM application software is downloaded by allowing a mobile terminal to access the IM application software provision server 13 through the Internet connection and download the IM application software from the server 13, as per a typical method. This IM application software is used for the mobile terminal 11 lacking an SIP function, and allows the mobile terminal 11 to use the IM service through communication with the IM proxy server 32. Thereafter, the user of the mobile terminal uses the IM service through the installed IM application software.

Next, the user of the first mobile terminal 11 lacking an SIP function transmits a login message to the IM proxy server 32 to register with the IMS network 30 at step S53. The IM proxy server 32, having received the login message, configures a REGISTER message, which is an SIP message, using user information included in the login message at step S54, and transmits the REGISTER message to the call session control server 31 in the IMS network 30 at step S55. The call session control server 31 performs a subscriber authentication procedure. If authentication has been successfully performed, the call session control server 31 transmits a 200 OK message, which is an SIP status message indicating successful authentication, to the IM proxy server 32 at step S56. If authentication has failed, the call session control server 31 transmits another SIP status message, indicating the cause of failure, to the IM proxy server 32. The IM proxy server 32, having received the SIP status message indicating the authentication results, converts the SIP status message into a login response message recognizable by the first mobile terminal 11 lacking an SIP function at step S57, and transmits the login response message to the first mobile terminal 11 at step S58. The login response message includes login success or failure information, and information about the cause of failure.

Thereafter, the first mobile terminal 11 lacking an SIP function can transmit an IM request message to the IM proxy server 32 so as to request registration or a change of status, the status of the other party, and addition or deletion of other parties with which to converse at step S59. The IM proxy server 32, having received the IM request message, configures a SUBSCRIBE message using the IM request message at step S60, and transmits the SUBSCRIBE message to the call session control server 31 at step S61. The call session control server 31 transmits the SUBSCRIBE message to the SIP based IM server 40 at step S62. The IM server 40 transmits an SIP message indicating the results of the reception and processing of the SUBSCRIBE message to the IM proxy server 32 through the call session control server 31 at steps S63 and S64. Then, the IM proxy server 32 converts the received SIP message into an IM response message recognizable by the first mobile terminal 11 lacking an SIP function at step S65, and transmits the IM response message to the first mobile terminal 11 at step S66.

Further, the SIP based IM server 40 transmits the results of the request included in the SUBSCRIBE message to the IM proxy server 32 through the call session control server 31 using a NOTIFY message at steps S67 and S68. The IM proxy server 32 converts the NOTIFY message into an IM NOTIFY message recognizable by the first mobile terminal 11 lacking an SIP function at step S69, and transmits the IM NOTIFY message to the first mobile terminal 11 lacking an SIP function at step S70. The first mobile terminal 11 lacking an SIP function transmits an IM result message used to confirm that the NOTIFY message has been received to the IM proxy server 32 at step S71. The IM proxy server 32 converts the IM result message into a corresponding SIP message recognizable by the call session control server 31 at step S72, and transmits the SIP message to the call session control server 31 at step S73. The call session control server 31 transmits the SIP message to the IM server 40 at step S74.

Thereafter, in order for the user of the first mobile terminal 11 lacking an SIP function to transmit an IM message to the user of a second mobile terminal 11′ having an SIP function, which is the other party, the first mobile terminal 11 lacking an SIP function configures an IM data message, including an IM message to be transmitted, and transmits the IM data message to the IM proxy server 32 at step S75. The IM proxy server 32 configures the IM data message as a MESSAGE at step S76, and transmits the MESSAGE to the SIP based IM server 40 through the call session control server 31 at steps S77 and S78. The SIP based IM server 40, having received the MESSAGE, transmits an SIP message, indicating the reception of the MESSAGE, to the IM proxy server 32 through the call session control server 31 at steps S79 and S80. The IM proxy server 32 converts the SIP message into an IM response message recognizable by the first mobile terminal 11 lacking an SIP function at step S81, and transmits the IM response message to the first mobile terminal 11 at step S82. Next, the IM server 40 transmits the MESSAGE to the second mobile terminal 11′ having an SIP function, that is, the other party (receiving party), which is a destination, through the call session control server 31 at step S83 and S84. In this case, if the transmission of IM data to the second mobile terminal 11′ has failed, the IM server 40 transmits an SIP message, including transmission failure information and information about a cause of transmission failure, to the IM proxy server 32 through the call session control server 31. The IM proxy server 32 converts the received SIP message into a message recognizable by the first mobile terminal 11 lacking an SIP function and transmits the message to the first mobile terminal 11. In this way, the first mobile terminal 11 lacking an SIP function determines whether the transmission of the IM data message has succeeded or failed, and detects a cause of failure if transmission has failed. In the meantime, the second mobile terminal 11′ having an SIP function transmits an SIP message indicating the reception results of the MESSAGE to the SIP based IM server 40 through the call session control server 31 at steps S85 and S86.

Then, the SIP based IM server 40 transmits an SIP message including the transmission results for the MESSAGE to the IM proxy server 32 through the call session control server 31 at steps S87 and S88. The IM proxy server 32, having received the SIP message including the MESSAGE transmission results, converts the SIP message into an IM transmission result message recognizable by the first mobile terminal 11 lacking an SIP function at step S89, and transmits the IM transmission result message to the first mobile terminal 11 lacking an SIP function at step S90.

As described above, the IM proxy server 32 functions to convert messages, received from the first mobile terminal 11 lacking an SIP function, into SIP status messages, such as SUBSCRIBE, NOTIFY or MESSAGE, and convert the SIP status messages into IM messages recognizable by the first mobile terminal 11 lacking an SIP function.

Further, the IM proxy server 32 functions to convert information included in the data fields of respective messages to correspond to the data fields of converted messages. For this operation, the IM proxy server 32 stores and manages required management information in the management data table 325.

As described above, the user of a mobile terminal lacking an SIP function can download IM application software to use an SIP based IM service through an IMS network, and use the IM service using the IM application software through an IM proxy server. That is, the IM proxy server converts a message received from a mobile terminal lacking an SIP function into a corresponding SIP message mapped thereto, and transmits the SIP message to an SIP based IM server through a call session control server, which is a component of the IMS network. Further, the IM proxy server converts an SIP message received from the SIP based IM server through the call session control server into a message recognizable by the mobile terminal lacking an SIP function, and transmits the message to the mobile terminal. Accordingly, the mobile terminal lacking an SIP function can use the SIP based IM service.

As described above, the present invention is advantageous in that a mobile terminal lacking an SIP function can use an SIP based IM service provided through the IMS network of a mobile communication network, so that the user of the mobile terminal lacking an SIP function can use the SIP based IM service even though the user, using the mobile terminal lacking an SIP function, does not purchase a new mobile terminal having an SIP function.

Further, the present invention is advantageous in that, since a user, using a typical mobile terminal lacking an SIP function, can use an SIP based IM service without purchasing a new mobile terminal having an SIP function, a service provider for providing the SIP based IM service can rapidly popularize the SIP based IM service, and a mobile communication network service provider can increase profits obtained from traffic resulting from the popularization of the service.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of providing a Session Initiation Protocol (SIP) based Instance Messaging (IM) service to a mobile terminal lacking an SIP function through an Internet-protocol Multimedia Subsystem (IMS) network, comprising:
the IM proxy server configuration step of configuring an IM proxy server which is connected to a call session control server of the IMS network communicating with an SIP based IM server and performs a proxy function in a mobile communication network so that the IM service is provided between the mobile terminal lacking an SIP function, connected to the IMS network through the mobile communication network, and the IM server through the IMS network;
the downloading step of the mobile terminal lacking an SIP function downloading IM application software from a corresponding server to use the SIP based IM service through communication with the IM proxy server; and
the message relaying step of the IM proxy server converting an IM message, received from the mobile terminal lacking an SIP function, into an SIP message mapped thereto, transmitting the SIP message to the IM server through the call session control server, converting an SIP message, received from the IM server through the call session control server, into an IM message recognizable by the mobile terminal lacking an SIP function, and transmitting the IM message to the mobile terminal lacking an SIP function.

2. The SIP based IM service provision method according to claim 1, wherein the IM proxy server configuration step is performed so that the IM proxy server is configured in the IMS network.

3. The SIP based IM service provision method according to claim 1, wherein each of the IM message and the SIP message includes a request message for providing the IM service between the mobile terminal lacking an SIP function and the IM server, an IM data message or a result message according to the request.

4. The SIP based IM service provision method according to claim 1, wherein the downloading step comprises the steps of:
the mobile terminal lacking an SIP function accessing an IM application software provision server through the Internet;
downloading the IM application software from the IM application software provision server; and
installing the downloaded IM application software in the mobile terminal.

5. The SIP based IM service provision method according to claim 1, wherein the message relaying step comprises:
the first step of the mobile terminal lacking an SIP function transmitting an IM data message, to be transmitted to at least one other mobile terminal, to the IM proxy server;
the second step of the IM proxy server converting the IM data message into a first SIP message mapped thereto, and transmitting the first SIP message to the IM server through the call session control server; and
the third step of the IM proxy server analyzing the first SIP message, extracting IM data to be transmitted to the other mobile terminal from the first SIP message, and transmitting a second SIP message including the extracted IM data to the other mobile terminal through the call session control server.

6. The SIP based IM service provision method according to claim 5, wherein the second step comprises the steps of:
the IM server transmitting a third SIP message including a response to the first SIP message to the IM proxy server through the call session control server; and
the IM proxy server converting the third SIP message into an IM transmission result message recognizable by the mobile terminal lacking an SIP function, and transmitting the IM transmission result message to the mobile terminal.

7. The SIP based IM service provision method according to claim 5, wherein the third step comprises the steps of:
if transmission of the IM data to the other mobile terminal has failed, the IM server transmitting a fourth SIP message, including transmission failure information and information about a cause of transmission failure, to the IM proxy server through the call session control server; and
the IM proxy server converting the fourth SIP message into a message recognizable by the mobile terminal lacking an SIP function, and transmitting the message to the mobile terminal.

8. The SIP based IM service provision method according to claim 1, wherein the message relaying step comprises the steps of:
the mobile terminal lacking an SIP function transmitting a login message to the IM proxy server to use the IM service;
the IM proxy server converting the login message into a fifth SIP message, and transmitting the fifth SIP message to the call session control server;
the call session control server performing a subscriber authentication procedure, and configuring authentication success results as a sixth SIP message and transmitting the sixth SIP message to the IM proxy server if authentication has been successfully performed; and
the IM proxy server converting the sixth SIP message into a login response message recognizable by the mobile terminal lacking an SIP function, and transmitting the login response message to the mobile terminal.

9. The SIP based IM service provision method according to claim 8, wherein the message relaying step further comprises the steps of:
if subscriber authentication has failed in the call session control server, the call session control server transmitting a seventh SIP message indicating authentication failure information and information about a cause of authentication failure to the IM proxy server; and
the IM proxy server converting the seventh SIP message into a login response message recognizable by the mobile terminal lacking an SIP function, and transmitting the login response message to the mobile terminal.

10. The SIP based IM service provision method according to claim 1, wherein the message relaying step comprises the steps of:
the mobile terminal lacking an SIP function transmitting an IM request message, including requests for registration or change of status thereof, status of IM service users, and registration, deletion and status information of at least one other mobile terminal, to the IM proxy server;
the IM proxy server converting the IM request message into an eighth SIP message, and transmitting the eighth SIP message to the IM server through the call session control server;
the IM server transmitting a ninth SIP message including a response to the eighth SIP message to the IM proxy server through the call session control server; and
the IM proxy server converting the ninth SIP message into an IM response message recognizable by the mobile terminal lacking an SIP function, and transmitting the IM response message to the mobile terminal.

11. The SIP based IM service provision method according to claim 10, wherein the message relaying step further comprises the steps of:
the IM server transmitting a tenth SIP message, including transmission results of the eighth SIP message from the mobile terminal, to the IM proxy server through the call session control server; and
the IM proxy server converting the tenth SIP message into an IM notify message recognizable by the mobile terminal lacking an SIP function, and transmitting the IM notify message to the mobile terminal.

12. A system for providing a Session Initiation Protocol (SIP) based Instance Messaging (IM) service to a mobile terminal lacking an SIP function through an Internet-protocol Multimedia Subsystem (IMS) network, comprising:
a mobile terminal lacking an SIP function, in which IM application software is installed to use the SIP based IM service;
an IM server for providing the SIP based IM service to the mobile terminal lacking an SIP function;
a call session control server of the IMS network for relaying SIP messages between the mobile terminal lacking an SIP function and the IM server; and
an IM proxy server connected to the call session control server through the IMS network, the IM proxy server performing a proxy function in a mobile communication network so that the IM service is provided between the mobile terminal lacking an SIP function, connected to the IMS network through the mobile communication network, and the IM server through the IMS network,
wherein the IM proxy server converts an IM message received from the mobile terminal lacking an SIP function into a corresponding SIP message mapped thereto, transmits the SIP message to the IM server through the call session control server, converts an SIP message received from the IM server through the call session control server into an IM message recognizable by the mobile terminal, and transmits the IM message to the mobile terminal.

13. The SIP based IM service provision system according to claim 12, wherein each of the IM message and the SIP message includes a request message for providing the IM service between the mobile terminal lacking an SIP function and the IM server, an IM data message or a result message according to the request.

14. An Instance Messaging (IM) proxy server for providing a Session Initiation Protocol (SIP) based Instance Messaging (IM) service to a mobile terminal lacking an SIP function through an Internet-protocol Multimedia Subsystem (IMS) network, the IM proxy server being connected to a call session control server of the IMS network that communicates with an SIP based IM server, the IM proxy server performing a proxy function in a mobile communication network so as to provide an IM service between a mobile terminal lacking an SIP function, connected to the IMS network through the mobile communication network, and the IM server, comprising:
an interface unit for interfacing with both the mobile terminal lacking an SIP function and the call session control server;
a non-SIP message generation and analysis unit for analyzing an IM message received from the mobile terminal lacking an SIP function through the interface unit, extracting data required to convert the IM message into an SIP message recognizable by the call session control server from the IM message, and then transmitting the SIP message to the interface unit;
an SIP message generation and analysis unit for analyzing an SIP message received from the call session control server through the interface unit, extracting data required to convert the SIP message into an IM message recognizable by the mobile terminal lacking an SIP function from the SIP message, and then transmitting the IM message to the interface unit; and
a message conversion unit for converting the IM message received from the non-SIP message analysis and generation unit into an SIP message mapped thereto, transmitting the SIP message to the non-SIP message analysis and generation unit, converting the SIP message received from the SIP message analysis and generation unit into an IM message mapped thereto, and transmitting the IM message to the SIP message analysis and generation unit.

15. The IM proxy server according to claim 14, further comprising a management data table for storing and managing data required for data mapping according to conversion of the IM message or SIP message performed by the message conversion unit.

16. The IM proxy server according to claim 14, wherein each of the IM message and the SIP message includes a request message for providing the IM service between the mobile terminal lacking an SIP function and the IM server, an IM data message or a result message according to the request.
